(19) United States
(12) Patent Application Publication
(10) Pub. No.: US 2025/0365387 A1
(43) Pub. Date: Nov. 27, 2025

(54) IMAGE FORMATION APPARATUS, IMAGE PROCESSING METHOD, AND STORAGE MEDIUM

(71) Applicant: CANON KABUSHIKI KAISHA, Tokyo (JP)

(72) Inventor: RYUJI YAMANAKA, Tokyo (JP)

(21) Appl. No.: 19/196,242

(22) Filed: May 1, 2025

(30) Foreign Application Priority Data
May 24, 2024 (JP) 2024-084774

(51) Int. Cl. H04N 1/60; G06F 3/12; H04N 1/58

(52) U.S. Cl. CPC H04N 1/6094; G06F 3/1208; G06F 3/1244; G06F 3/1254; H04N 1/58

(57) ABSTRACT

An image formation apparatus configured to execute printing and fixation of color data included in printing data and printing and fixation of particular color data included in the printing data to overlap with each other on a printing medium, includes: a first processing unit configured to scale the printing data with a first scaling factor and execute rasterization processing in which raster data for each color is outputted; and a second processing unit configured to scale raster data of a particular color out of the raster data for each color with a second scaling factor different from the first scaling factor.

### BACKGROUND OF THE INVENTION

### Field of the Invention

The present disclosure relates to an image formation apparatus, an image processing method, and a storage medium.

### Description of the Related Art

An image formation apparatus that forms an image by ejecting ink onto a printing medium may use an overprinting method to form the image multiple times in the same region of the printing medium. For example, in order to obtain a printing result on which a particular color is printed below a basic color, only the particular color is formed and fixed once on the printing medium, and then the basic color is formed and fixed thereon. As a method of fixation, for example, there has been known a method of heating the printing medium after the ink ejection. However, in this fixation step, the printing medium may be expanded or contracted, and misalignment or unexpected size of the image of the printing result may occur. That is, after the particular color is formed, if the basic color is formed in a state in which the printing medium is contracted by the first fixation, misalignment between the image of the particular color and the image of the basic color may occur. Additionally, since the printing medium is expanded in the second fixation after the basic color formation, the basic color portion of the printing result may be greater than a size desired by the user.

To deal with this problem, in Japanese Patent Laid-Open No. 2015-102574 (PTL 1), a method of solving misalignment of sizes between a particular color and a basic color by forming an image after enlarging or contracting a particular color image has been proposed.

However, the method in PTL 1 has a possibility that scaling processing appropriate for a printing step cannot be implemented.

### SUMMARY OF THE INVENTION

An image formation apparatus according to the present disclosure is an image formation apparatus configured to execute printing and fixation of color data included in printing data and printing and fixation of particular color data included in the printing data to overlap with each other on a printing medium, including: a first processing unit configured to scale the printing data with a first scaling factor and execute rasterization processing in which raster data for each color is outputted; and a second processing unit configured to scale raster data of a particular color out of the raster data for each color with a second scaling factor different from the first scaling factor.

Further features of the present invention will become apparent from the following description of exemplary embodiments with reference to the attached drawings.

### BRIEF DESCRIPTION OF THE DRAWINGS

FIG. 1 is a diagram illustrating an example of an overall configuration of a system including an image formation apparatus according to the present disclosure;

FIG. 2 is a block diagram illustrating a functional configuration of the image formation apparatus;

FIG. 3 is a flowchart illustrating a flow of image formation processing;

FIG. 4 is a flowchart illustrating a flow of printing image generation processing;

FIG. 5 is a diagram illustrating an example of a scaling factor table;

FIG. 6 is a diagram illustrating the printing image generation processing and a flow of data;

FIG. 7 is a diagram illustrating transition of an image size on a printing medium in a process of printing;

FIG. 8 is a diagram illustrating an example of transition of the image size on the printing medium in a second embodiment;

FIG. 9 is a diagram illustrating an example of a scaling factor table in the second embodiment;

FIG. 10 is a diagram illustrating the printing image generation processing and the flow of data in the second embodiment;

FIG. 11 is a diagram illustrating an example of transition of the image size on the printing medium in a third embodiment;

FIG. 12 is a diagram illustrating an example of the scaling factor table in the third embodiment;

FIG. 13 is a diagram illustrating the printing image generation processing and the flow of data in the third embodiment; and

FIG. 14 is a diagram illustrating another example of the scaling factor table.

### DESCRIPTION OF THE EMBODIMENTS

Hereinafter, embodiments of the present disclosure are described in detail with reference to the drawings. However, configurations described in the following embodiments are merely examples, and the scope of the present disclosure is not limited by the configurations described in the embodiments. Note that, the same configurations and processing are described using the same reference numerals.

### First Embodiment

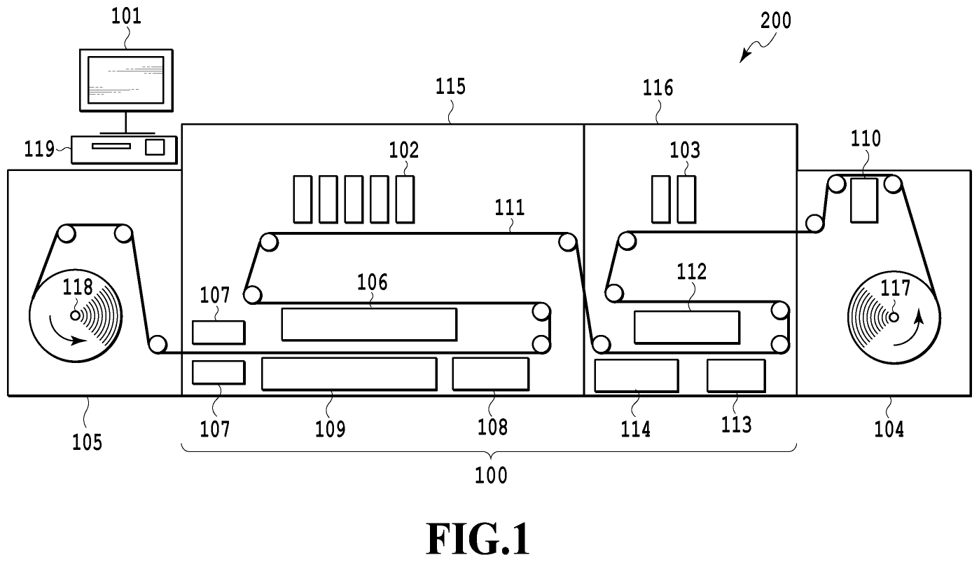

FIG. 1 is a diagram illustrating a configuration example of an image formation system 200 according to a first embodiment of the present disclosure. The image formation system 200 forms an image on continuous paper (hereinafter, referred to as roll paper 111), which is a printing medium in a roll shape that allows for continuous image formation. The image formation system 200 includes an image formation apparatus 100 including an annex 116 and a main section 115, a feeding device 104, a discharge device 105, a UI operation panel 101, and a control PC 119. The annex 116 performs particular color printing as pre-printing. In the particular color printing, for example, printing of white data included in printing data is performed. The main section 115 performs basic color printing as additional printing. In the basic color printing, for example, printing of basic color data (cyan (C), magenta (M), yellow (Y), and black (K)) included in the printing data is performed. That is, it is also possible to say that the image formation apparatus 100 is a digital printing apparatus that performs the pre-printing and the additional printing.

Note that, the printing medium used in the present embodiment is not limited to only paper used by a general image formation apparatus and widely includes a printing medium that can accept ink such as vinyl, cloth, a plastic film, a metal plate, glass, ceramics, wood, and leather. In the following descriptions, the printing medium may be also referred to as a substrate or a sheet. Additionally, although a case where the roll paper is used is described in the present embodiment, it is not limited to the roll paper and the present disclosure is also applicable to cut paper. Moreover, the particular color is not limited to white and may include another color such as a fluorescent color and a metallic color. The basic color is not limited to cyan (C), magenta (M), yellow (Y), and black (K) and may include another color.

The feeding device 104 supplies the annex 116 of the image formation apparatus 100 with the roll paper 111. The feeding device 104 rotates a paper core of the roll paper 111 about a rotation axis 117 to unwind the roll paper 111 wound around the paper core, and the roll paper 111 is conveyed to the annex 116 of the image formation apparatus 100 at a constant speed by way of multiple rollers (a conveyance roller, a feeding roller, and so on).

The discharge device 105 winds up the roll paper 111 discharged from the main section 115 of the image formation apparatus 100. The discharge device 105 rotates the roll paper 111 conveyed from the main section 115 of the image formation apparatus 100 by way of multiple rollers (for example, a conveyance roller, a discharge roller, and so on) about a rotation axis 118 at a constant speed into a roll shape as a deliverable of the roll paper 111. In the discharge device 105, the roll paper 111 is wound around a paper core of the rotation axis 118 and held in a roll shape.

Before the printing starts, the roll paper 111 is set from the feeding device 104 to the discharge device 105 by way of a predetermined conveyance path in the image formation apparatus 100. Specifically, the roll paper 111 is mounted in the feeding device 104, passes above a skew correction device 110 inside the feeding device 104 to be fed to the annex 116, and first, passes below a second image formation unit 103.

The second image formation unit 103 includes a printing head of the particular color (for example, white ink or the like) other than the basic color for the printing and forms an image of the particular color on the roll paper 111. Many nozzles to eject the ink are provided to the printing head, and the image is formed on the roll paper 111 by ejecting the ink from the nozzle onto the roll paper 111. Thus, the second image formation unit 103 prints the image of the white data included in the printing data, for example. In addition, the roll paper 111 is fed to the main section 115 after passing above a dryer device 112 and cooler devices 113 and 114 sequentially and then passes below a first image formation unit 102.

The first image formation unit 102 is provided downstream of the second image formation unit 103 in a roll paper conveyance direction and includes a printing head of each printing basic color (CMYK) to form an image of the printing basic color on the roll paper 111. Many nozzles to eject the ink are provided to the printing head of each color, and the image is printed on the roll paper 111 by ejecting the ink from the nozzles onto the roll paper 111. Thus, the first image formation unit 102 prints the image of the basic color data included in the printing data, for example. In addition, the roll paper 111 passes above a dryer device 106, cooler devices 108 and 109 sequentially, passes through a connection scanner device 107, and is then discharged to the discharge device 105. In the discharge device 105, the roll paper 111 is wound around the rotation axis 118 to be wound up into a roll shape.

In a case of performing printing, an operator sets the roll paper 111 inside the image formation system 200 and then inputs an image formation job (hereinafter, simply referred to as a printing job) into the control PC 119 of the image formation system 200. After the printing job is inputted, the operator provides an instruction to start printing by pressing a start key on the UI operation panel 101.

Note that, regarding a printing method (an image formation method) of the image formation apparatus 100 according to the present embodiment, an ink jet method that uses ink as printing material is described as an example; however, the present disclosure is not limited thereto. For example, the present embodiment is applicable to a thermal printer (a sublimation type, a thermal transfer type, and the like), a dot-impact printer, an LED printer, an electrophotographic method of a laser printer and the like, and an image formation apparatus that uses other various printing methods.

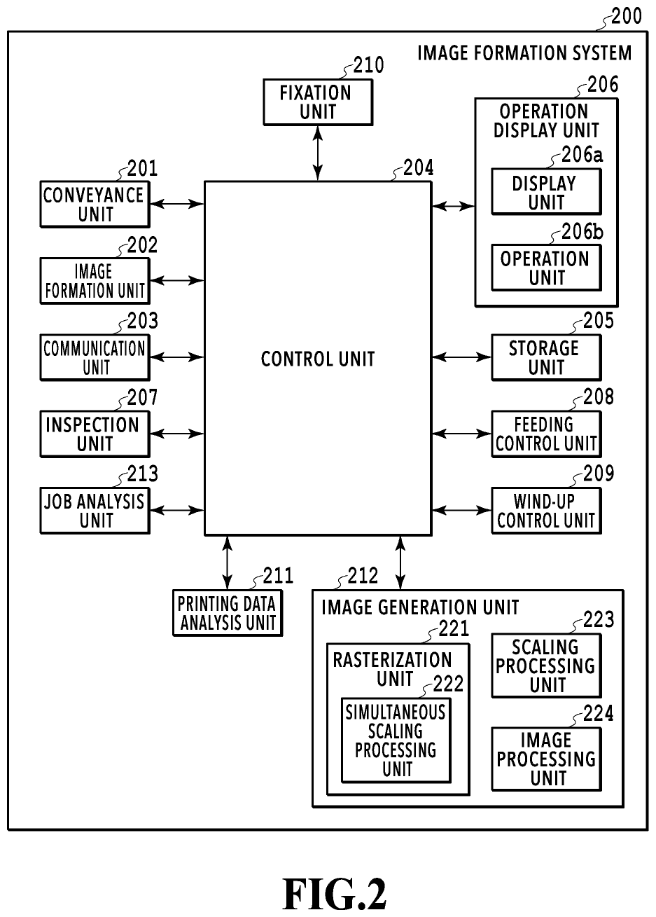

FIG. 2 is a functional block diagram illustrating a control configuration of the image formation system 200. The image formation system 200 includes a conveyance unit 201, an image formation unit 202, a communication unit 203, a control unit 204, a storage unit 205, an operation display unit 206, an inspection unit 207, a feeding control unit 208, a wind-up control unit 209, and a fixation unit 210. The image formation system 200 additionally includes a printing data analysis unit 211, an image generation unit 212, and a job analysis unit 213.

The conveyance unit 201 controls the conveyance of the roll paper 111 inside the image formation apparatus 100. The image formation unit 202 controls image formation operations in the first image formation unit 102 and the second image formation unit 103 and outputs a printing image generated by the image generation unit 212 onto the printing medium (the roll paper 111).

The communication unit 203 includes a communication control module such as a LAN card, for example. The communication unit 203 transmits and receives various types of data to and from an external device connected to a communication network such as a LAN and a WAN. The communication unit 203 receives data of the printing job from the external device.

The control unit 204 includes a CPU, a RAM, and the like, for example. The CPU of the control unit 204 reads out various programs such as a system program and a processing program stored in the storage unit 205 to deploy to the RAM and executes various types of processing according to the deployed program. For example, the control unit 204 can perform image formation processing to execute the printing job according to an instruction by the operator.

The storage unit 205 includes a non-volatile semiconductor memory (a so-called flash memory) such as a ROM, an HDD, an SSD, and the like, for example. The storage unit 205 stores various programs including a system program and a processing program executed by the control unit 204 and various types of data required to execute those programs.

The operation display unit 206 includes a liquid crystal display with a touch panel, for example, and includes a display unit 206a and an operation unit 206b. According to a display control signal inputted from the control unit 204, the display unit 206a displays various types of information on the display screen of the UI operation panel 101. The operation unit 206b accepts various input operations by the operator via various operation keys such as a numeric keypad and a start key displayed on the UI operation panel 101 and outputs an operation signal to the control unit 204. For example, in a case where the printing job is executed, the operation display unit 206 accepts setting of job information by the operator. For example, the operator can set the printing medium used, a printing speed, the number of sheets to be printed, the number of prints, a printing length, a printing weight, a printing diameter, and other various conditions, arbitrarily.

The inspection unit 207 controls confirmation of a printing state in the image formation apparatus 100. The inspection unit 207 confirms whether the first image formation unit 102 and the second image formation unit 103 have no ejection failure by causing the first image formation unit 102 and the second image formation unit 103 to print a pattern for ejection failure inspection and causing a scanner of the connection scanner device 107 to read a printing result. In a case where there is the ejection failure, information indicating the result is provided to the control unit 204. As the inspection method, in addition to the method in which the pattern for inspection is printed and read by the scanner, various methods such as a method of directly reading a printed product on a sheet by a camera and a scanner to inspect and a method of monitoring an ejection state from the nozzle may be applicable.

The feeding control unit 208 controls the feeding of the roll paper 111 by the feeding device 104. The wind-up control unit 209 controls the discharging of the roll paper 111 by the discharge device 105.

The fixation unit 210 fixes the ink by controlling the dryer device 106 and the cooler devices 108 and 109 to dry and cool the roll paper 111 after passing through the first image formation unit 102 of the main section 115. Additionally, the fixation unit 210 fixes the ink by controlling the dryer device 112 and the cooler devices 113 and 114 to dry and cool the roll paper 111 after passing through the second image formation unit 103 of the annex 116. Heating conditions in the dryer devices 106 and 112 are determined by a table 500 described later and controlled by the control unit 204.

The printing data analysis unit 211 analyzes whether the received printing data (instructed to be outputted) includes particular color data. The printing data is inputted in a predetermined data format such as a portable document format (PDF), for example. Information indicating whether the printing data includes the particular color data is held in advance in a header portion of the printing data as additional information, for example. That is, in a case where information of a color other than the basic color (CMYK) is held in the header portion of the printing data, the printing data analysis unit 211 determines that the printing data includes the particular color data. In a case where the information of the color other than the basic color (CMYK) is not held in the header portion of the printing data, the printing data analysis unit 211 determines that the printing data does not include the particular color data.

Based on the received printing data, the image generation unit 212 generates the printing image for each color (C, M, Y, K, and the particular color). The image generation unit 212 includes a rasterization unit 221, a scaling processing unit 223, and an image processing unit 224.

The rasterization unit 221 converts the received printing data (instructed to be outputted) into a raster format and outputs the printing data as raster data that is image data for each color. The rasterization unit 221 includes a simultaneous scaling processing unit 222. The simultaneous scaling processing unit 222 performs scaling processing on all pieces of the printing data with a predetermined scaling factor in a case where the rasterization processing is performed. Since the simultaneous scaling processing unit 222 performs the scaling processing on all pieces of the printing data, all the colors of the basic color (C, M, Y, K) and the particular color are scaled by single scaling processing. In the present embodiment, the simultaneous scaling processing unit 222 performs the scaling processing on the printing data with a scaling factor of the basic color data held in advance. The simultaneous scaling processing and the scaling factor are described later.

The scaling processing unit 223 performs the scaling processing on the raster data related to the particular color out of the raster data of each color (C, M, Y, K, and the particular color) after the rasterization unit 221 is outputted. Since the raster data of the particular color is scaled with the scaling factor of the basic color by the simultaneous scaling processing unit 222, scaling for restoring this to the scaling factor of the particular color is performed. That is, as the scaling factor in the scaling processing unit 223, a scaling factor that is obtained by correcting the scaling factor of the particular color based on the scaling factor of the basic color is used. Hereinafter, this scaling factor is referred to as a differential scaling factor. Specifically, the differential scaling factor is determined by the following expression (1). Note that, units of the scaling factor and the differential scaling factor are percentage, which is a scaling factor with respect to a length of a side. It is a state in which the raster data of the particular color scaled with the scaling factor of the basic color by the simultaneous scaling processing unit 222 is scaled by the scaling factor of the particular color with the processing by the scaling processing unit 223.

$$differential scaling factor = scaling factor of particular color \div scaling factor of basis color \times 100 \qquad ( 1 )$$

The image processing unit 224 performs necessary image processing such as halftone processing and the like on the raster data after the scaling processing and converts the raster data into data of an ink ejection level indicating the amount of ink ejected per unit of ink color.

The job analysis unit 213 analyzes a job ticket (data describing the sheet used, the number of prints, and the like) and returns to the control unit 204 as printing setting.

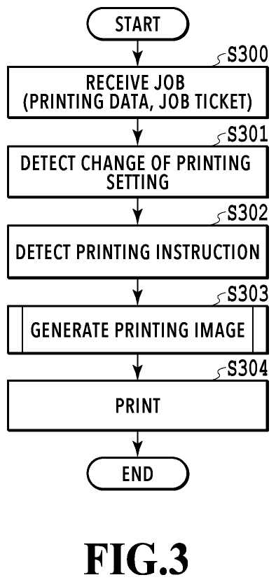

FIG. 3 is a flowchart illustrating a flow of the entire image formation processing according to the present embodiment. The present flowchart is started once the printing job (the printing data and the job ticket) transmitted from the external device is received. Note that, the job ticket describes the information on the printing medium used and the printing setting such as the number of prints. A series of processing illustrated in FIG. 3 is implemented with the CPU of the control unit 204 of the image formation apparatus 100 reading out the program stored in the storage unit 205 and deploying to the RAM to execute. Alternatively, a part of or all the functions of steps in FIG. 3 may be implemented by hardware such as an ASIC and an electronic circuit.

In S300, the control unit 204 accepts the printing job transmitted from the external device via the communication unit 203 and saves the printing data into the storage unit 205. In addition, the control unit 204 instructs the job analysis unit 213 to analyze the job ticket and saves printing setting information obtained as an analysis result into the storage unit 205.

In S301, once the control unit 204 detects an operation to change the printing setting by the operator via the operation display unit 206, the control unit 204 updates the printing setting information saved in the storage unit 205 into changed contents.

In S302, the control unit 204 detects that a printing instruction is provided by the operator via the operation display unit 206.

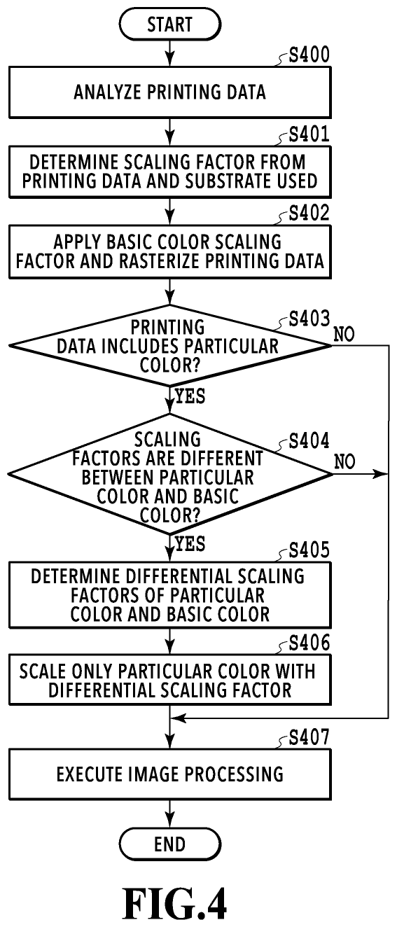

In S303, the control unit 204 instructs the printing data analysis unit 211 and the image generation unit 212 to generate the printing image. The printing data analysis unit 211 and the image generation unit 212 analyzes the printing data and generates the printing image. Details of this processing are described with reference to FIG. 4.

In S304, the control unit 204 starts a printing operation based on the printing image and the printing setting. That is, the conveyance of the roll paper 111 is started by the conveyance unit 201, the feeding control unit 208, and the wind-up control unit 209, and the image formation unit 202 causes the first image formation unit 102 and the second image formation unit 103 to perform the printing operation based on the printing data.

FIG. 4 is a flowchart illustrating a flow of printing image generation processing according to the present embodiment. The present flowchart is executed in S303 once the control unit 204 detects the printing instruction by the operator in S302 in FIG. 3. A series of processing illustrated in FIG. 4 is implemented with the CPU of the control unit 204 of the image formation apparatus 100 reading out the program stored in the storage unit 205 and deploying to the RAM to execute. Alternatively, a part of or all the functions of steps in FIG. 4 may be implemented by hardware such as an ASIC and an electronic circuit.

In S400, the control unit 204 instructs the printing data analysis unit 211 to analyze whether the printing data stored in the storage unit 205 includes the particular color data. As a result of the processing in S400, the control unit 204 obtains either information indicating that there is the particular color data or information indicating that there is no particular color data.

In S401, the control unit 204 obtains the scaling factor to be applied to the printing job from a scaling factor table 500 stored in the storage unit 205 and reads the scaling factor on the RAM. The control unit 204 specifies the scaling factor based on the information as follows.
The information indicating whether there is the particular color data. This information is obtained as the analysis result in S400.
The information on the type of the sheet (the substrate) used. This information is designated by the job ticket. Alternatively, in a case where the operator changes the setting via the operation display unit 206 after the job ticket is accepted, it is the information after the change.

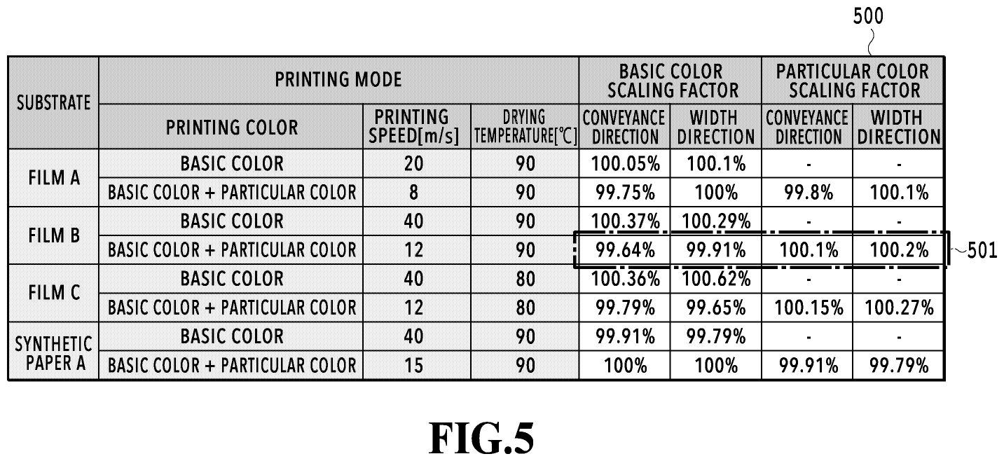

FIG. 5 is a diagram illustrating an example of the scaling factor table 500. The scaling factor table 500 is stored in the storage unit 205. As a value of the scaling factor stored in the scaling factor table 500, a value that is determined based on an expansion and contraction degree of the sheet is set in advance. Additionally, the information of the scaling factor is not necessarily held in the format of a table and may be held in another format. Moreover, it is possible to change the value of the scaling factor without restrictions by the operator via the operation display unit 206. Furthermore, a function to print an adjustment pattern and automatically adjust the scaling factor based on a reading result by the connection scanner device 107 may be provided.

In the scaling factor table 500, as the value of the scaling factor, at least the scaling factor for the basic color and the scaling factor for the particular color are defined. Additionally, the scaling factor for the basic color and the scaling factor for the particular color are each set for also a conveyance direction of the sheet and a width direction orthogonal to the conveyance direction. Moreover, the scaling factor for the basic color and the scaling factor for the particular color are set for each type of the sheet (the substrate) and each heating condition (the printing speed and a drying temperature). Furthermore, the scaling factor for the basic color is set for each printing mode (printing color).

The reason of holding the scaling factor for each type of the sheet (the substrate) is because a direction (to contract or expand) and a degree (how much the sheet contracts or expands) of the expansion and contraction are different for each type of the sheet (the substrate). The reason of holding the scaling factor for each printing mode is because the heating conditions (the number of times, time, the temperature, and the like) of the sheet are different depending on the printing mode. The reason of holding the scaling factor for each of the conveyance direction and the width direction is because the degree (how much the sheet contracts or expands) of the expansion and contraction is different depending on the direction of the sheet.

For example, in a case of the printing job indicating that the type of the sheet (the substrate) is “film B” and the printing mode is “basic color+particular color, printing speed of 12 m/second, and drying temperature of 90° C.”, 99.64% in the conveyance direction and 99.91% in the width direction are held as the scaling factors of the basic color as indicated in a frame 501. Additionally, 100.1% in the conveyance direction and 100.2% in the width direction are held as the scaling factors of the particular color. Note that, the value in the scaling factor table 500 illustrated in FIG. 5 is an example, and another value may be set.

Referring back to FIG. 4. In S402, the control unit 204 instructs the image generation unit 212 to generate the printing image. In this process, the control unit 204 passes the scaling factor read into the RAM in S401 to the image generation unit 212. In addition, the control unit 204 passes the printing data and the information about this printing data indicating whether there is the particular color to the image generation unit 212. The image generation unit 212 instructs the rasterization unit 221 to rasterize the printing data. The rasterization unit 221 passes the scaling factor of the basic color to the simultaneous scaling processing unit 222 and performs the scaling processing of the printing data. Thereafter, the scaled printing data is converted into the raster format and outputted as the raster data of each color (C, M, Y, K, and the particular color). That is, five types of image data, which are a C image, an M image, a Y image, a K image, and a particular color image, are outputted. At this stage, all the five types of image data are in a state of being scaled with the scaling factor of the basic color.

In S403, based on the information indicating whether there is the particular color in the printing data, the image generation unit 212 determines whether the printing data includes the particular color data. If it is determined that the particular color data is included (S403; Yes), the process proceeds to S404. If it is determined that the particular color data is not included (S403; No), the process proceeds to S407.

In S404, the image generation unit 212 judges whether the scaling factor obtained in S401 is different between the particular color and the basic color. If it is judged that the scaling factor is different between the particular color and the basic color (S404; Yes), the process proceeds to S405. If it is judged that the scaling factor matches between the particular color and the basic color (S404; No), the process proceeds to S407.

In S405, the image generation unit 212 determines the differential scaling factor between the particular color and the basic color based on the expression (1).

$$differential scaling factor = scaling factor of particular color \div scaling factor of basis color \times 100 \qquad ( 1 )$$

For example, in a case where the scaling factors in the frame 501 in FIG. 5 are set, the following values are determined. Note that, the calculation result is rounded from the third place after the decimal point.

differential scaling factor in conveyance direction=100.1÷99.64×100=100.46

differential scaling factor in width direction=100.2÷99.91×100=100.29

In S406, the image generation unit 212 instructs the scaling processing unit 223 to perform the scaling processing of the raster data of the particular color (the particular color image). Out of the five types of image data outputted in S402, which are the C image, the M image, the Y image, the K image, and the particular color image, the scaling processing unit 223 performs the scaling processing on the particular color image with the differential scaling factor determined in S405.

At the stage where the processing in S406 ends, the image data in a state in which the C image, the M image, the Y image, and the K image are scaled with the scaling factor of the basic color and the particular color image is scaled with the scaling factor of the particular color is obtained.

In S407, the image generation unit 212 instructs the image processing unit 224 to perform the image processing. The image processing unit 224 performs necessary image processing on the raster data of each color (the C image, the M image, the Y image, the K image, and the particular color image) and converts the raster data into the data of the ink ejection level indicating the amount of ink ejected per unit of ink color. Thereafter, the processing in the present flowchart ends.

In the processing in the present flowchart, in a case where the particular color data is not included (S403; NO) and in a case where the scaling factor is the same between the particular color and the basic color (S404; No), the processing in S405 and S406, that is, the scaling processing of the particular color image with the differential scaling factor is omitted.

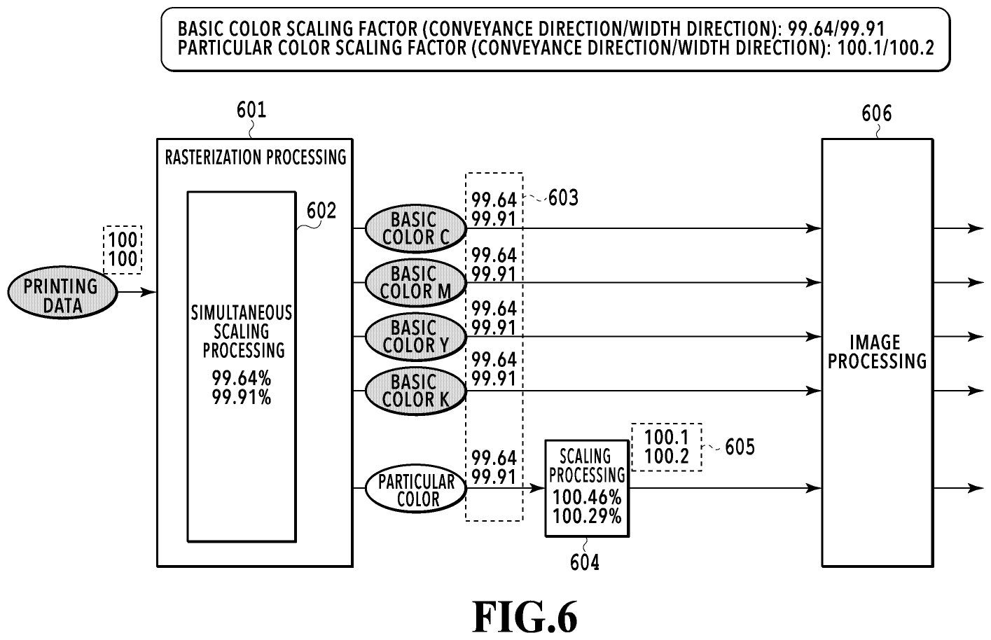

FIG. 6 is an explanatory view schematically illustrating the processing and a flow of the data in the printing image generation processing in FIG. 4. FIG. 6 illustrates that the further to the right side of FIG. 6, the more the processing progresses, while a rectangular with a solid line in FIG. 6 represents the processing and an ellipse represents the data. Additionally, a numerical value in FIG. 6 represents the scaling factor (unit; percentage), and a numerical value in a rectangular with a dotted line represents a size of the data at that point. The size of the data is a value in a case of assuming that the printing data (the received printing data) is 100.

A case where the scaling factors indicated in the frame 501 in FIG. 5 are applied is described with reference to FIG. 6. In this example, the scaling factors of the basic color are 99.64% in the conveyance direction and 99.91% in the width direction, and the scaling factors of the particular color are 100.1% in the conveyance direction and 100.2% in the width direction.

For example, once the printing data is inputted in a data format such as PDF, in a step 601, the rasterization unit 221 performs the rasterization processing. During the rasterization processing, in a step 602, the simultaneous scaling processing unit 222 performs the scaling processing on all pieces of the printing data with the scaling factor of the basic color. Therefore, at the stage where the rasterization processing ends, all pieces of the raster data (the images) including the particular color have the data size corresponding to the basic color scaling factor. Specifically, the C image, the M image, the Y image, the K image, and the particular color image are all contracted with the scaling factors of 99.64% in the conveyance direction and 99.91% in the width direction as indicated in a dotted line frame 603. Next, in a step 604, the scaling processing unit 223 performs the scaling processing on only the particular color image with the above-described differential scaling factor. As indicated by the above-described expression (1), the differential scaling factor is a value obtained by dividing the scaling factor of the particular color by the scaling factor of the basic color and multiplying the obtained value by 100. At that point, the particular color image has the size corresponding to the particular color scaling factor. Specifically, the particular color image on which the scaling processing is performed with the scaling factors of the basic color (in a state of 99.64% in the conveyance direction and 99.91% in the width direction) is enlarged with the differential scaling factor of 100.46% in the conveyance direction and the differential scaling factor of 100.29% in the width direction. As a result, the particular color image of 100.1% in the conveyance direction and 100.2% in the width direction is generated. Thereafter, in a step 606, the image processing unit 224 performs image processing necessary for the printing execution on the image data of all the colors, and the printing image generation processing ends.

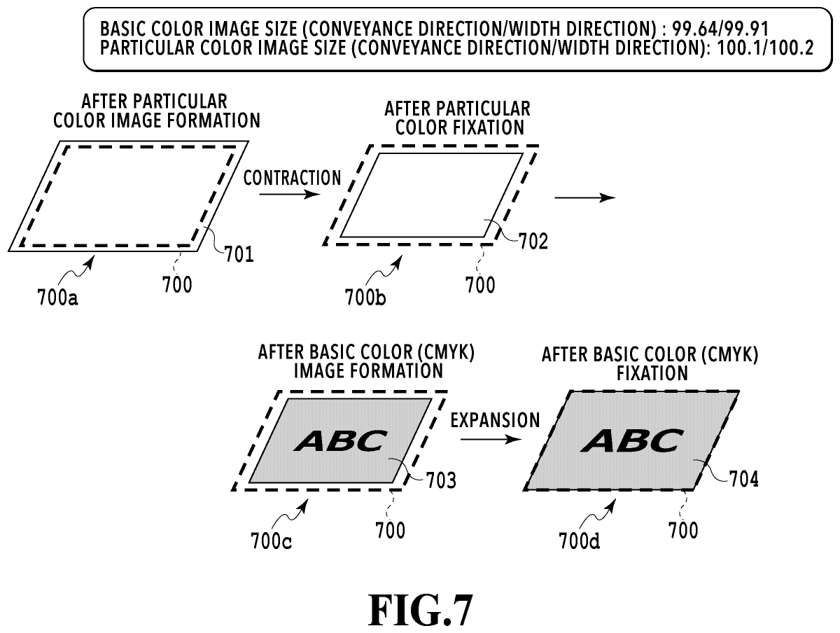

FIG. 7 is a diagram schematically illustrating transition of the image size on the roll paper in the printing process in S304 in FIG. 3. FIG. 7 illustrates that the processing proceeds in the order from a state 700a to a state 700d, while plain quadrangles 701 and 702 with a solid line represent the particular color image and quadrangles 703 and 704 with a solid line including a colored “ABC” character string represent the basic color image. Additionally, a numerical value in a dotted line frame 700 in FIG. 7 represents the size of the printing data inputted into the image formation apparatus 100, that is, the size of the printing result that is desired by the operator and a designer. FIG. 7 is described by using a case where the scaling processing is performed with the scaling factors indicated in the frame 501 in FIG. 5, that is, the example of the printing images (C, M, Y, K, and the particular color) generated in the description of FIG. 6.

The state 700a indicates a state immediately after the particular color image is printed by the second image formation unit 103, and a particular color image 701 enlarged by the scaling processing is outputted on the roll paper. The state 700b indicates a state immediately after the first fixation is performed by the dryer device 112 and the cooler devices 113 and 114, and it is a state in which the roll paper is contracted and a particular color image 702 is contracted. The state 700c indicates a state immediately after the first image formation unit 102 prints a basic color image 703, and a state in which the basic color image 703 contracted by the scaling processing is outputted on the contracted particular color image 702 is indicated. The state 700d indicates a state after the second fixation is performed by the dryer device 106 and the cooler devices 108 and 109. It is indicated that a particular color and basic color image 704 on the roll paper is enlarged by the expansion of the roll paper and eventually the size of the printing data 700, that is, a printing result desired by the operator is obtained.

As described above, according to the image formation apparatus 100 of the present embodiment, the scaling factors of the basic color and the particular color included in the printing data are managed by the image formation apparatus 100, and in a case where the image formation apparatus 100 performs the rasterization, the scaling processing is performed for all the colors simultaneously. After the rasterization, the image formation apparatus 100 performs the scaling processing for only the data of the particular color. Therefore, it is possible to perform the scaling processing appropriate for the printing step. According to this procedure, it is possible to suppress increase of the processing time and deterioration of the image quality in the scaling processing of the printing data. The present embodiment is favorable particularly in RIP processing (the rasterization) in a case where there is a restriction that the scaling processing including the basic color and the particular color is performed.

Additionally, the image formation apparatus of the present embodiment can execute the scaling processing of the data of all the colors on an apparatus side with no need for a printer driver. Therefore, the present embodiment is favorable in a case where the printing data created by the designer is submitted to a printing company in a finished size and is printed by an apparatus of the printing company. That is, it is unnecessary to perform the scaling processing in advance on the printing data before the submission according to the change of the size of the printing medium. Since the direction and the degree of the expansion and contraction of the sheet due to heat are different depending on the type of the printing medium and the printing step, it is difficult to set the scaling factor. However, according to the present disclosure, the designer can create and submit the printing data with no concern for the expansion and contraction of the sheet in the printing and fixation steps.

Additionally, in a case where false scaling processing is performed before the submission for instance, it is necessary to perform the scaling processing many times to fix into a proper scaling factor, and there is a concern of deterioration of the image quality and increase of an operation time. Particularly, since the scaling processing after the rasterization is performed individually for each ink color, a lot of processing time is required. For example, after the rasterization without scaling, five times of the scaling processing with the scaling factors of the corresponding pieces of the raster data (the corresponding image data of C, M, Y, K, and the particular color) are required. Comparing with this case, in a case where the procedure in the present disclosure is used, the time required for the scaling processing is reduced. Additionally, since the number of times of scaling of the basic color is suppressed to once, the deterioration of image quality is suppressed. Although the scaling processing for the particular color is performed twice, it is considered that an effect on the image quality is small because the color unevenness does not occur easily with the single color and also because the particular color is usually used as a foundation purpose of the basic color and is unlikely to be conspicuous.

### Second Embodiment

In the first embodiment, an example in which the particular color is printed and fixed first and then the basic color is printed and fixed thereon to overlap the particular color is described. However, the printing image generation processing of the present disclosure is also applicable to a case of the opposite order, that is, a case where the basic color is printed and fixed first and then the particular color is printed and fixed thereon to overlap the basic color. Hereinafter, a case where the basic color is printed and fixed first and then the particular color is printed and fixed thereon to overlap the basic color is described as a second embodiment.

In a system configuration of the image formation system 200 of the second embodiment, unlike the first embodiment (FIG. 1), the main section 115 in which the basic color is printed is arranged upstream in a sheet conveyance direction, and the annex 116 in which the particular color is printed is arranged downstream of the main section 115. Along with this, the connection scanner device 107 is provided in the annex 116. Other apparatus configuration and functional configuration are similar to that in the first embodiment.

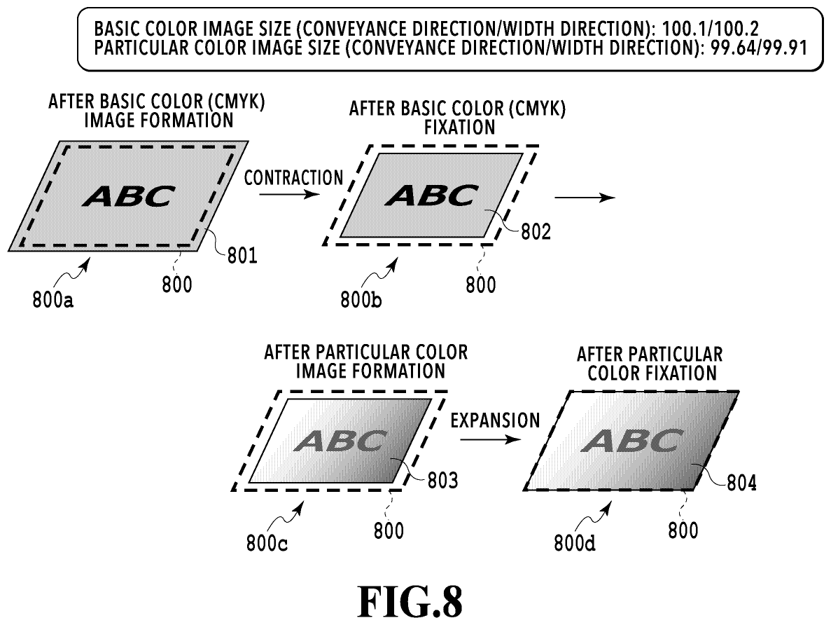

FIG. 8 is a diagram schematically illustrating transition of the image size on the roll paper in the printing process. FIG. 8 illustrates that the processing progresses in the order from a state 800a to a state 800d. Additionally, quadrangles 801 and 802 with a solid line including a colored “ABC” character string represent the basic color image, and gradation quadrangles 803 and 804 with a solid line represent the particular color image. Moreover, a dotted line frame 800 in FIG. 8 represents the size of the printing data inputted in the image formation apparatus 100, that is, the size of the printing result desired by the operator.

In the second embodiment, a case where the roll paper is contracted first by the fixation after the printing of the basic color and thereafter the roll paper is expanded by the fixation after the printing of the particular color as illustrated in FIG. 8 is described as an example. The state 800a indicates a state immediately after the image formation of the basic color is performed, and a basic color image 801 enlarged by the scaling processing is outputted on the roll paper. The state 800b indicates a state immediately after the first fixation is performed in which the roll paper is contracted and a basic color image 802 is contracted smaller than that in the state 800a. The state 800c indicates a state immediately after the image formation of the particular color is performed, and a state in which a particular color image 803 contracted by the scaling processing is outputted to overlap the contracted basic color image 802 is indicated. The state 800d indicates a state after the second fixation is performed. A particular color and basic color image 804 on the sheet is expanded to have the size of the printing data eventually, that is, the printing result desired by the operator.

In a case where the printing is performed according to the process illustrated in FIG. 8, since the printing order of the basic color and the particular color is different from that in the first embodiment, the scaling factor held in the scaling factor table is also different from that in the first embodiment.

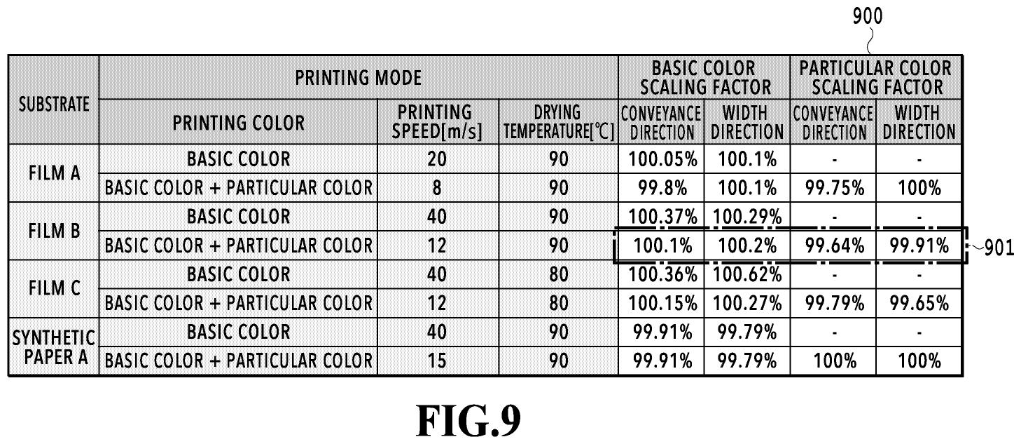

FIG. 9 is a diagram illustrating an example of a scaling factor table 900 of the second embodiment. For example, in a case of the printing job indicating that the type of the sheet (the substrate) is “film B” and the printing mode is “basic color+particular color, printing speed of 12 m/second, and drying temperature of 90° C.”, 100.1% in the conveyance direction and 100.2% in the width direction are held as the scaling factors of the basic color as indicated in a frame 901. Additionally, 99.64% in the conveyance direction and 99.91% in the width direction are held as the scaling factors of the particular color. Comparing with the scaling factors (the frame 501) of the same type of the sheet (the substrate) and in the same printing mode in the scaling factor table 500 (FIG. 5) in the first embodiment, the opposite values are held between the basic color and the particular color.

The scaling factor table 900 is held in the storage unit 205. As a value of the scaling factor stored in the scaling factor table 900, a value that is determined based on the expansion and contraction degree of the sheet is set in advance. Additionally, the information of the scaling factor is not necessarily held in the format of a table and may be held in another format. Moreover, it is possible to change the value of the scaling factor without restrictions by the operator via the operation display unit 206. Note that, the value in the scaling factor table 900 illustrated in FIG. 9 is an example and another value may be set.

A flow of the printing image generation processing in the second embodiment is similar to that in the first embodiment. Note that, the value in the scaling factor table 900 illustrated in FIG. 9 is referred to in the scaling processing during the rasterization processing in S402 and in the processing of determining the differential scaling factor in S405. The differential scaling factor between the particular color and the basic color in S405 is determined based on the above-described expression (1).

For example, in a case where the scaling factors indicated in the frame 901 in FIG. 9 are set, the following values are determined. Note that, the calculation result is rounded from the third place after the decimal point.

$$differential scaling factor in conveyance direction = 99.64 \div 100.1 \times 100 = 99.54 \\ differential scaling factor in width direction = 99.91 \div 100.2 \times 100 = 99.71$$

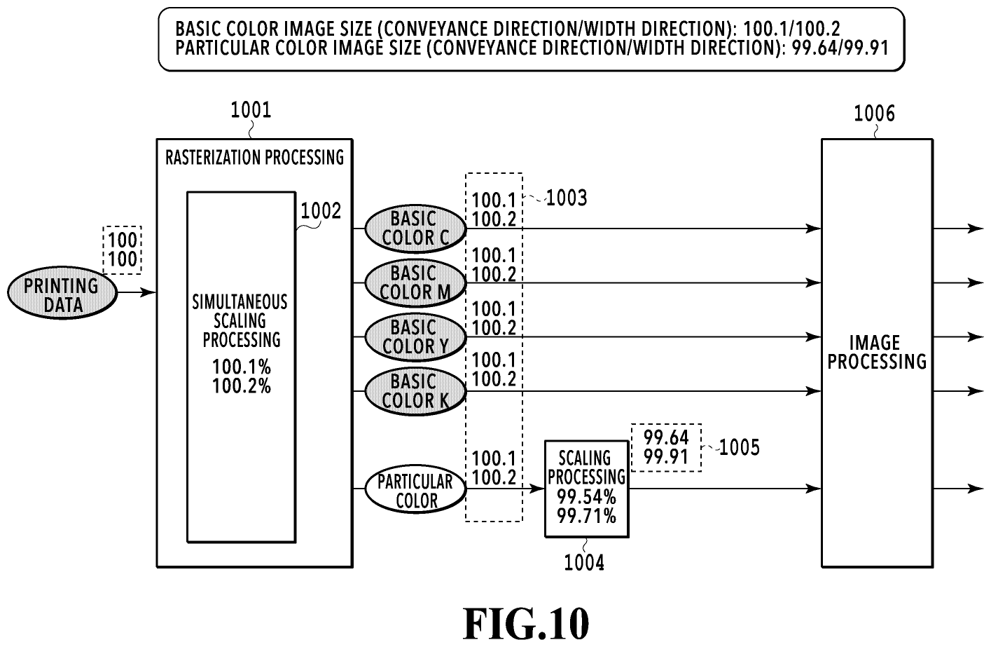

FIG. 10 is an explanatory view schematically illustrating the processing and a flow of the data in the second embodiment. Once the printing data is inputted, in a step 1001, the rasterization unit 221 performs the rasterization processing. During the processing, in a step 1002, the simultaneous scaling processing unit 222 performs the scaling processing on all pieces of the printing data with the scaling factor of the basic color. Therefore, at the stage where the rasterization processing ends, all pieces of the raster data (the images) including the particular color have the data size corresponding to the basic color scaling factor. Specifically, the C image, the M image, the Y image, the K image, and the particular color image are all images contracted with the scaling factors of 100.1% in the conveyance direction and 100.2% in the width direction as indicated in a dotted line frame 1003. Next, in a step 1004, the scaling processing unit 223 performs the scaling processing on only the particular color image with the above-described differential scaling factor. As indicated by the expression (1), the differential scaling factor is a value obtained by dividing the scaling factor of the particular color by the scaling factor of the basic color and multiplying the obtained value by 100. At that point, the particular color image has the size corresponding to the particular color scaling factor. Specifically, the particular color image (a state of 100.1% in the conveyance direction and 100.2% in the width direction) on which the scaling processing is performed with the scaling factor of the basic color is contracted with the differential scaling factor of 99.54% in the conveyance direction and the differential scaling factor of 99.71% in the width direction. As a result, the particular color image of 99.64% in the conveyance direction and 99.91% in the width direction is generated. Thereafter, in a step 1006, the image processing unit 224 performs image processing necessary for the printing execution on the image data of all the colors, and the printing image generation processing ends.

Thus, in the image formation apparatus 100, the scaling factors of the basic color and the particular color included in the printing data are managed, and all the scaling processing is performed; therefore, the designer who creates the printing data can create the printing data with no concern for the printing order in the printing steps and the expansion and contraction of the sheet in each step. Additionally, as with the first embodiment, increase of the processing time and deterioration of the image quality are suppressed.

### Third Embodiment

In a third embodiment, a case where printing is performed in the order of a first particular color SP1, the basic color, and a second particular color SP2 is described. That is, a case where the first particular color SP1 is printed and fixed, the basic color is printed and fixed thereon to overlap the first particular color SP1, and in addition, the second particular color SP2 different from the first particular color SP1 is printed and fixed in the same region on the roll paper is described.

In a system configuration of the image formation system 200 in the third embodiment, in addition to the image formation system 200 of the first embodiment, an annex in which the second particular color SP2 is printed is additionally arranged downstream of the main section 115. That is, from the upstream of the roll paper in the conveyance direction, the annex 116 for the printing of the first particular color SP1, the main section 115 for the basic color printing, and the annex for the printing of the second particular color SP2 are arranged in this order.

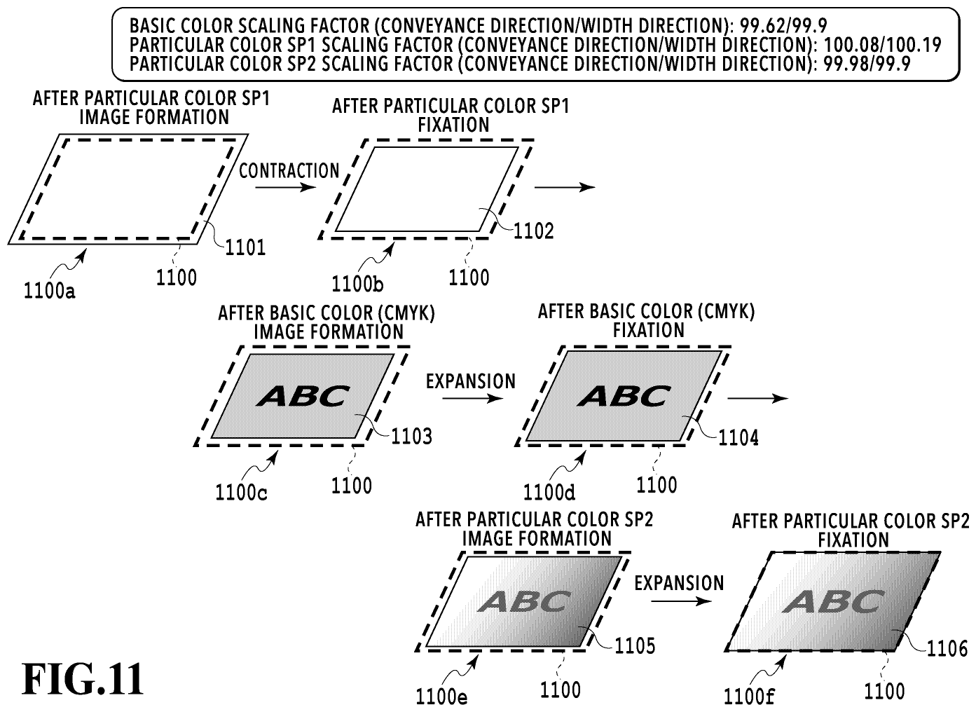

FIG. 11 is a diagram schematically illustrating transition of the image size on the roll paper in the printing process of the third embodiment. FIG. 11 illustrates that the processing progresses in the order from a state 1100a to a state 1100f. Additionally, a dotted line frame 1100 in FIG. 11 represents the size of the printing data inputted in the image formation apparatus 100, that is, the size of the printing result desired by the designer.

In the third embodiment, an example in which the roll paper is contracted by the fixation after the printing of the image of the first particular color SP1, the roll paper is expanded by the subsequent fixation after the printing of the basic color image, and additionally the roll paper is expanded by the subsequent fixation after the printing of the image of the second particular color SP2 is described.

The state 1100a indicates a state immediately after the printing of the first particular color SP1 is performed, and an image 1101 of the first particular color SP1 enlarged by the scaling processing is outputted on the roll paper. The state 1100b indicates a state immediately after the first fixation is performed in which the roll paper is contracted and an image 1102 of the first particular color SP1 is contracted smaller than that in the state 1100a. The state 1100c indicates a state immediately after a basic color image 1103 is outputted to overlap the image of the first particular color SP1, and the basic color image 1103 contracted by the scaling processing is outputted. The state 1100d indicates a state immediately after the second fixation is performed in which the roll paper is expanded and an image 1104 is expanded greater than that in a state of the state 1100c. Note that, at this stage, the image is in a state smaller than the size of the printing data (the dotted line frame 1100). The state 1100e indicates a state immediately after the printing of an image 1105 of the second particular color SP2, and the image 1105 of the second particular color SP2 contracted by the scaling processing is outputted to overlap the contracted image 1104 of the first particular color SP1 and the basic color. The state 1100f indicates a state after the third fixation is performed. The image on the roll paper is expanded by the expansion of the roll paper, and eventually the size of the printing data, that is, a printing result 1106 desired by the operator is obtained.

In a case where the printing is performed according to the process illustrated in FIG. 11, since the process of the contraction and the expansion is different from that in the first and second embodiments, the scaling factor held in the scaling factor table is also different from that in the first and second embodiments.

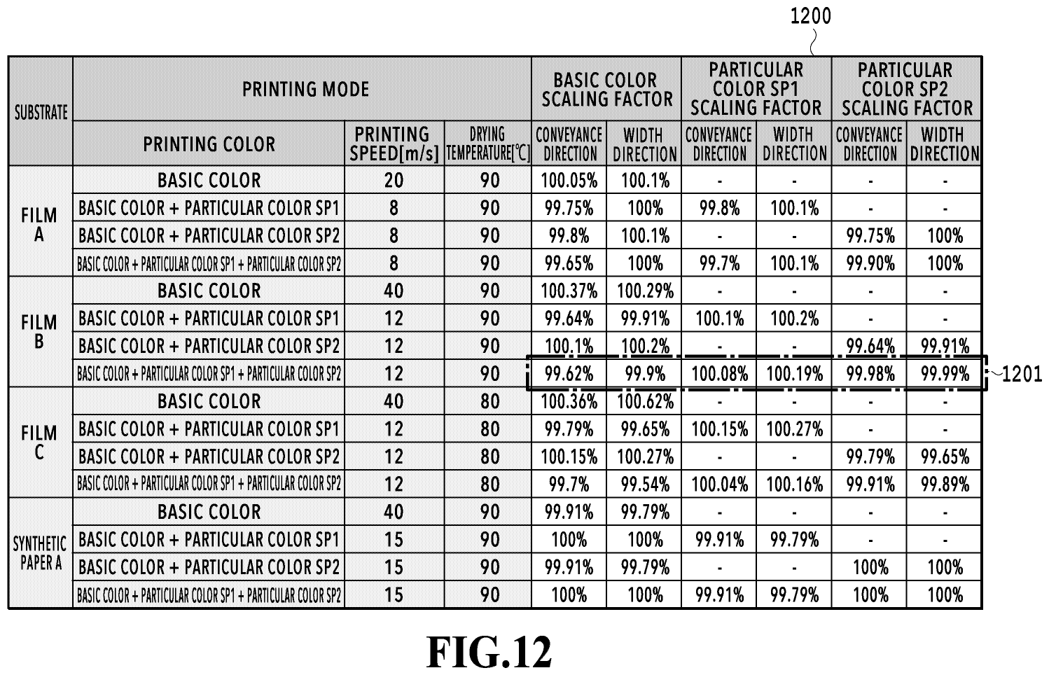

FIG. 12 is a diagram illustrating an example of a scaling factor table 1200 in the third embodiment. For example, in a case of the printing job indicating that the type of the sheet (the substrate) is “film B” and the printing mode is “basic color+particular color SP1+particular color SP2, printing speed of 12 m/second, and drying temperature of 90° C.”, the scaling factors indicated in a frame 1201 are held. As illustrated in FIG. 12, 99.62% in the conveyance direction and 99.9% in the width direction are held as the scaling factors of the basic color. Additionally, two types of the scaling factors of the particular color are held. As the scaling factors of the first particular color SP1, 100.08% in the conveyance direction and 100.19% in the width direction are held. As the scaling factors of the second particular color SP2, 99.98% in the conveyance direction and 99.99% in the width direction are held.

In the scaling factor table 1200 in FIG. 12, four types of printing modes are set for each sheet (the substrate), and different values are set for the scaling factor in each printing mode depending on the type of the printing mode.

Specifically, the scaling factors of four printing modes, which are “basic color”, “basic color+particular color SP1”, “basic color+particular color SP2”, and “basic color+particular color SP1+particular color SP2”, are set for each sheet (substrate). In each printing mode, the printing speed and the heating condition such as the drying temperature are also different. For example, in a case of the printing job indicating that the sheet (the substrate) is “film A” and the printing mode is “basic color, printing speed of 20 m/second, and drying temperature of 90° C.”, the scaling factors of the basic color held are 100.05% in the conveyance direction and 100.1% in the width direction. In a case of the same sheet (the substrate) that is “film A” and the printing mode of “basic color+particular color SP1, printing speed of 8 m/second, and drying temperature of 90° C.”, 99.75% in the conveyance direction and 100% in the width direction are held as the scaling factors of the basic color. Additionally, 99.8% in the conveyance direction and 100.1% in the width direction are held as the scaling factors of the first particular color SP1.

In a case where the sheet (the substrate) is “film A” and the printing mode is “basic color+particular color SP2, printing speed of 8 m/second, and drying temperature of 90° C.”, 99.8% in the conveyance direction and 100.1% in the width direction are held as the scaling factors of the basic color. Additionally, 99.75% in the conveyance direction and 100% in the width direction are held as the scaling factors of the second particular color SP2. In a case where the sheet (the substrate) is “film A” and the printing mode is “basic color+particular color SP1+particular color SP2, printing speed of 8 m/second, and drying temperature of 90° C.”, 99.65% in the conveyance direction and 100% in the width direction are held as the scaling factors of the basic color. Additionally, 99.7% in the conveyance direction and 100.1% in the width direction are held as the scaling factors of the first particular color SP1. Moreover, 99.90% in the conveyance direction and 100% in the width direction are held as the scaling factors of the second particular color SP2.

The scaling factor table 1200 is held in the storage unit 205. As a value of the scaling factor stored in the scaling factor table 1200, a value that is determined based on the expansion and contraction degree of the sheet is set in advance. Additionally, the information of the scaling factor is not necessarily held in the format of a table and may be held in another format. Moreover, it is possible to change the value of the scaling factor without restrictions by the operator via the operation display unit 206. Note that, the value in the scaling factor table 1200 illustrated in FIG. 12 is an example, and another value may be set.

A flow of the printing image generation processing in the third embodiment is similar to that in the first embodiment. Note that, the value in the scaling factor table 1200 illustrated in FIG. 12 is referred to in the scaling processing during the rasterization processing in S402 and in the processing of determining the differential scaling factor in S405, and the differential scaling factor is determined for each type of the particular color. Additionally, the scaling processing of the particular color image in S406 is executed for each of a first particular color image and a second particular color image.

For example, in a case where the scaling factors indicated in the frame 1201 in FIG. 12 are set, the following differential scaling factors are determined for each type of the particular color based on the above-described expression (1). Note that, the calculation result is rounded from the third place after the decimal point.

As for first particular color SP1:

$$differential scaling factor in conveyance direction = 100.08 \div 99.62 \times 100 = 100.46 \\ differential scaling factor in width direction = 100.19 \div 99.9 \times 100 = 10029$$

As for second particular color SP2:

$$differential scaling factor in conveyance direction = 99.98 \div 99.62 \times 100 = 100.36 \\ differential scaling factor in width direction = 99.99 \div 99.9 \times 100 = 100.09$$

In S406, the image generation unit 212 instructs the scaling processing unit 223 to perform the scaling processing of the raster data of the first particular color SP1 and the scaling processing of the raster data of the second particular color SP2. The scaling processing unit 223 performs the scaling processing on the raster data of the particular color outputted in S402 with the differential scaling factors of the particular color and the basic color determined in S405.

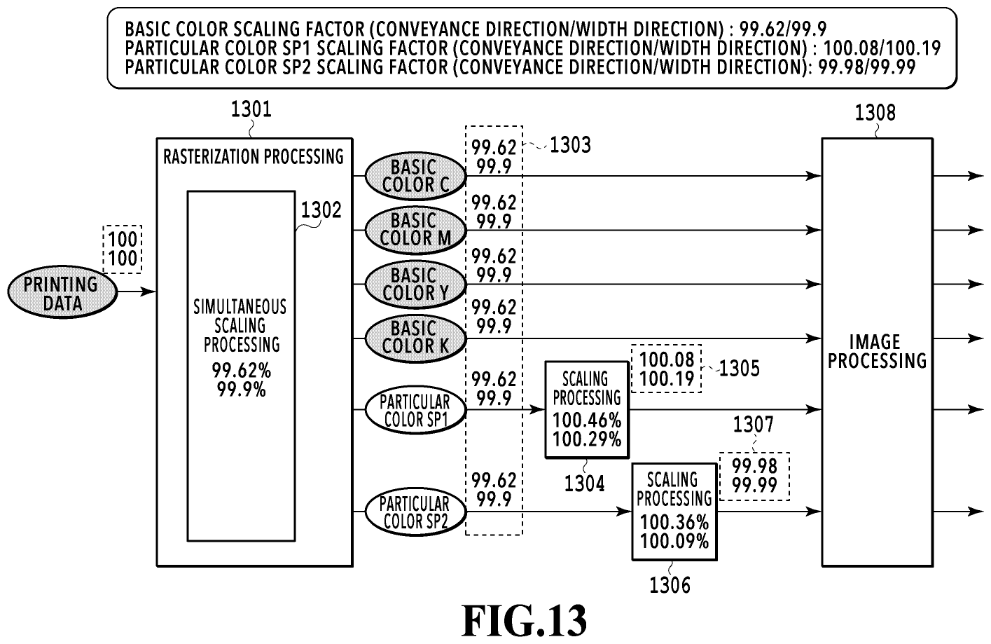

FIG. 13 is an explanatory view schematically illustrating processing a flow of the data in the third embodiment. Once the printing data is inputted, in a step 1301, the rasterization unit 221 performs the rasterization processing. During the processing, in a step 1302, the simultaneous scaling processing unit 222 performs the scaling processing on all pieces of the printing data with the scaling factor of the basic color. Therefore, at the stage where the rasterization processing ends, all pieces of the raster data (the images) including the particular color have the data size corresponding to the basic color scaling factor. Specifically, the C image, the M image, the Y image, the K image, the first particular color image, and the second particular color image are all images contracted with the scaling factors of 99.62% in the conveyance direction and 99.9% in the width direction.

Next, in a step 1304, the scaling processing unit 223 performs the scaling processing on the image of the first particular color SP1 with the above-described differential scaling factor. The differential scaling factor is a value obtained by dividing the scaling factor of the particular color by the scaling factor of the basic color and multiplying the obtained value by 100 as indicated by the expression (1). At that point, the first particular color image has the size corresponding to the particular color scaling factor. That is, the first particular color image on which the scaling processing is performed with the scaling factor of the basic color is enlarged with the differential scaling factor of 100.46% in the conveyance direction and the differential scaling factor of 100.29% in the width direction. As a result, the first particular color image of 100.08% in the conveyance direction and 100.19% in the width direction is generated.

Thereafter, in a step 1306, the second particular color image on which the scaling processing is performed with the scaling factor of the basic color is enlarged with the differential scaling factor of 100.36% in the conveyance direction and the differential scaling factor of 100.09% in the width direction. As a result, the second particular color image of 99.98% in the conveyance direction and 99.99% in the width direction is generated. Thereafter, in a step 1308, the image processing unit 224 performs image processing necessary for the printing execution on the image data of all the colors, and the printing image generation processing ends.

Note that, although the scaling processing in the step 1306 is executed after the scaling processing in the step 1304 in FIG. 13, the scaling processings in the step 1304 and the step 1306 may be performed at the same time. Note that, in a case where the scaling processings in the step 1304 and the step 1306 are performed at the same time, it is preferable to include a CPU that has a proper performance taking into consideration a load during other processing concurrently executed.

As described above, also in a case where the printing job including multiple types of particular color is received, it is possible to manage the scaling factors of the basic color and the particular color included in the printing data and to perform all the scaling processing in the image formation apparatus 100. The designer who creates the printing data can create the printing data with no concern for the expansion and contraction of the sheet, and the usability is improved.

### <Modification 1>

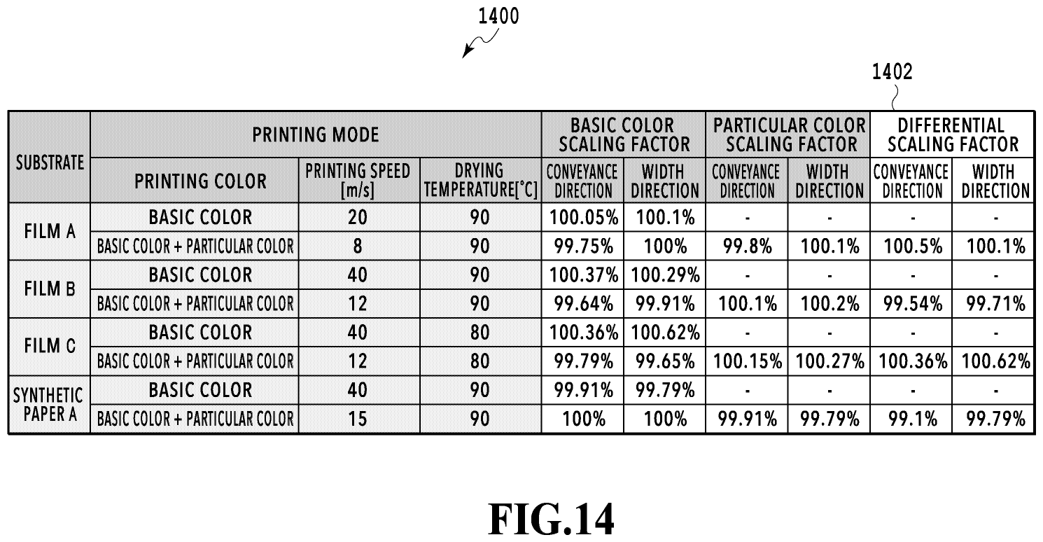

In each embodiment described above, a procedure in which the control unit 204 performs the simultaneous scaling processing on the printing data with the scaling factor of the basic color, determines the differential scaling factor based on the scaling factors of the particular color and the basic color, and performs the scaling processing on the raster data of the particular color with the differential scaling factor is described. Additionally, as illustrated in FIG. 5, the scaling factor table 500 holds the scaling factor of the basic color and the scaling factor of the particular color. However, it is not limited to this example, and as a scaling factor table 1400 illustrated in FIG. 14, the scaling factor of the basic color and a differential scaling factor 1402 may be held in advance. As with each embodiment described above, the differential scaling factor is the scaling factor determined based on the expression (1). In this case, the determination of the differential scaling factor in S405 is omitted from the printing image generation processing illustrated in FIG. 4, and a procedure in which the control unit 204 performs the scaling processing of the particular color using the differential scaling factor held in the scaling factor table 1400 in S406 is applied.

### <Modification 2>

In each embodiment described above, an example in which the printing data included in the printing job received by the image formation system 200 is the printing data of the finished size is described. In addition, in the image formation system 200, the control unit 204 executes the printing image generation processing illustrated in FIG. 4, specifies the scaling factor according to the sheet (the substrate) information and the information indicating whether there is the particular color that are included in the printing data, and executes two stages of the scaling processing, which are the simultaneous scaling and the scaling of the particular color data. However, processing of a part of or all the printing image generation processing illustrated in FIG. 4 may be executed by a data processing apparatus, which is an apparatus outside the image formation system 200, by using the printer driver. The data processing apparatus is a computer including a control unit, a storage unit, a communication unit, and the like and can communicate with the image formation system 200 and an external apparatus via the communication unit. Additionally, the data processing apparatus includes the printer driver to process the received printing data.

The printer driver includes a program to perform analysis of the printing data, specification of the scaling factor, and the simultaneous scaling processing of the printing data with the scaling factor of the basic color in S400 to S402. The control unit of the data processing apparatus executes the processing according to the program and transmits the printing job including the printing data after the simultaneous scaling processing to the image formation system 200. In this case, the image formation system 200 obtains the printing job including the printing data after the simultaneous scaling processing with the scaling factor of the basic color. Then, the control unit 204 of the image formation system 200 executes the processings in and after S403. That is, in a case where the printing data includes the data of the particular color, the control unit 204 of the image formation system 200 executes the scaling processing of the particular color image with the differential scaling factor.

Alternatively, the printer driver (the data processing apparatus) may perform the processings in S400 to S406, that is, analysis of the printing data, specification of the scaling factor, the simultaneous scaling processing of the printing data with the scaling factor of the basic color, and the scaling processing of the particular color with the differential scaling factor. In this case, the printing job including the raster data of each color after the scaling processing is transmitted to the image formation system 200. The image formation system 200 receives the printing job including the printing image on which the scaling processing for images of all the colors is performed by the printer driver and executes the image processing in S407. Thereafter, the printing processing is executed.

As above, preferable embodiments of the present disclosure are described; however, the present disclosure is not limited to the above-described embodiments, and various modifications and changes are possible within the gist thereof. For example, the exemplified process of the contraction and expansion of the sheet is an example, and there may also be a case where the process of the expansion and contraction of the sheet is changed depending on conditions. For example, in the first and second embodiments, a case where the sheet is contracted in the first printing and fixation and the sheet is expanded in the second printing and fixation is exemplified. Additionally, in the third embodiment, a case where the sheet is contracted in the first printing and fixation and the sheet is expanded in the second and third printing and fixation is exemplified. In addition, the processing of the present disclosure may also be applicable in a case where further contraction occurs by the printing and fixation after being contracted and a case where further expansion occurs by the printing and fixation after being expanded.

According to the present disclosure, it is possible to perform scaling processing appropriate for a printing step.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084774, filed May 24, 2024, which is hereby incorporated by reference wherein in its entirety.

What is claimed is:

1. An image formation apparatus configured to execute printing and fixation of color data included in printing data and printing and fixation of particular color data included in the printing data to overlap with each other on a printing medium, comprising:
a first processing unit configured to scale the printing data with a first scaling factor and execute rasterization processing in which raster data for each color is outputted; and
a second processing unit configured to scale raster data of a particular color out of the raster data for each color with a second scaling factor different from the first scaling factor.

2. The image formation apparatus according to claim 1, wherein
the first scaling factor is a scaling factor of the color data,
the second scaling factor is a scaling factor obtained by correcting a scaling factor of the particular color data with the scaling factor of the color data.

3. The image formation apparatus according to claim 1, further comprising:
a holding unit configured to hold in advance information of a scaling factor of the color data and information of a scaling factor of the particular color data; and
a determination unit configured to determine a differential scaling factor obtained by correcting the scaling factor of the particular color data with the scaling factor of the color data, wherein
the first processing unit performs scaling processing on the printing data by using the scaling factor of the color data held in the holding unit as the first scaling factor, and
the second processing unit scales the raster data of the particular color by using the differential scaling factor determined by the determination unit as the second scaling factor.

4. The image formation apparatus according to claim 1, further comprising:
a holding unit configured to hold in advance information of the first scaling factor and information of the second scaling factor.

5. The image formation apparatus according to claim 1, wherein
the color data includes at least one of cyan data, magenta data, yellow data, and black data, and
the particular color data includes white color data at least.

6. The image formation apparatus according to claim 1, further comprising:
an analysis unit configured to analyze whether the printing data includes the particular color data, wherein
in a case where the analysis unit analyzes that the printing data includes the particular color data, processing by the first processing unit and processing by the second processing unit are executed, and
in a case where the analysis unit analyzes that the printing data does not include the particular color data, processing by the first processing unit is executed but processing by the second processing unit is not executed.

7. The image formation apparatus according to claim 3, further comprising:
a judgment unit configured to judge whether the scaling factor of the color data and the scaling factor of the particular color data held in the holding unit are the same, wherein
in a case where the judgment unit judges that the scaling factor of the color data and the scaling factor of the particular color data are different, processing by the first processing unit and processing by the second processing unit are executed, and
in a case where the judgment unit judges that the scaling factor of the color data and the scaling factor of the particular color data are the same, processing by the first processing unit is executed but processing by the second processing unit is not executed.

8. The image formation apparatus according to claim 1, wherein
the first scaling factor and the second scaling factor are set for each of a conveyance direction of the printing medium and a width direction of the printing medium.

9. The image formation apparatus according to claim 1, wherein
the first scaling factor and the second scaling factor are each set for each type of the printing medium.

10. The image formation apparatus according to claim 1, wherein
the first scaling factor is set for each of a first printing mode in which the particular color data and the color data are printed and a second printing mode in which the color data is printed but the particular color data is not printed.

11. The image formation apparatus according to claim 1, wherein
the first scaling factor and the second scaling factor are set for each heating condition in a dryer device used for the fixation.

12. The image formation apparatus according to claim 1, further comprising:
a reception unit configured to receive a printing job including the printing data and information of the printing medium used for the printing of the printing data, wherein
based on the information of the printing medium received by the reception unit, the first scaling factor and the second scaling factor to be applied to the printing job are specified.

13. The image formation apparatus according to claim 1, wherein
the image formation apparatus executes the printing and fixation of the particular color data before the printing and fixation of the color data.

14. The image formation apparatus according to claim 1, wherein
the image formation apparatus executes the printing and fixation of the color data before the printing and fixation of the particular color data.

15. The image formation apparatus according to claim 1, wherein
in a case where the printing data includes a plurality of types of the particular color data, the second processing unit correspondingly performs the scaling with the second scaling factor according to each of the plurality of types of the particular color data.

16. The image formation apparatus according to claim 1, wherein
as the first scaling factor and the second scaling factor, a value corresponding to a case where the printing medium is contracted in first printing and fixation and the printing medium is expanded in second printing and fixation is set.

17. An image processing method in which image processing is executed on printing data including color data and particular color data, comprising:
scaling the printing data with a first scaling factor for execution of rasterization processing and executing the rasterization processing in which raster data for each color is outputted; and
scaling raster data of a particular color out of the raster data for each color with a second scaling factor different from the first scaling factor.

18. A non-transitory computer readable storage medium storing a program which causes a computer to execute a data processing method in which printing data including color data and particular color data are processed, the data processing method comprising:
scaling the printing data with a first scaling factor for execution of rasterization processing and executing the rasterization processing in which raster data for each color is outputted; and
scaling raster data of a particular color out of the raster data for each color with a second scaling factor different from the first scaling factor.
